(19) United States
(12) Patent Application Publication
(10) Pub. No.: US 2019/0241275 A1
(43) Pub. Date: Aug. 8, 2019

(54) TROUBLESHOOTING METHOD, AIRCRAFT, SERVER AND CONTROL DEVICE

(71) Applicant: SZ DJI TECHNOLOGY CO., LTD., Shenzhen (CN)

(72) Inventors: Jiahang YING, Shenzhen (CN); Chaobin CHEN, Shenzhen (CN); Chang GENG, Shenzhen (CN)

(21) Appl. No.: 16/385,246

(22) Filed: Apr. 16, 2019

Related U.S. Application Data
(63) Continuation of application No. PCT/CN2016/102793, filed on Oct. 21, 2016.

(51) Int. Cl. B64D 45/00; B64D 47/02; B64C 39/02; G06F 21/60

(52) U.S. Cl. CPC B64D 45/0015; B64D 47/02; B64C 2201/146; G06F 21/602; B64C 39/024

(57) ABSTRACT

A troubleshooting method includes receiving a locking instruction instructing to lock a target aircraft and locking the target aircraft according to the locking instruction.

### CROSS-REFERENCE TO RELATED APPLICATION

This application is a continuation of International Application No. PCT/CN2016/102793, filed on Oct. 21, 2016, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure generally relates to the field of aircraft and, more particularly, to a troubleshooting method, an aircraft, a server and a control device.

### BACKGROUND

With the development of flight technology, aircraft (e.g., UAV, i.e., unmanned aerial vehicle, also known as drone) has evolved from military use to broader civilian applications, such as UAV plant protection, UAV aerial photography, UAV forest fire monitoring. The civilian applications of the UAV also become the trend of future development.

Due to improper operations, machine malfunctions, etc., a UAV abnormally falls to the ground. After the UAV falls down, the event of the UAV being not damaged or having a little damage is referred as a UAV crash, which does not affect the UAV's internal structure. The UAV can still fly. Due to improper operations, machine malfunctions, etc., the UAV abnormally falls to the ground. After the UAV falls down, the UAV is damaged severely, affecting the internal structure, or after the UAV falls down, the UAV is completely broken down, resulting in the UAV incapable of flight, which is referred as a UAV explosion. In short, the UAV explosion is the worst case of the UAV crash. A worst aftermath of UAV accident is that a user can only take the remaining remote controller home, because the malfunctioning UVA loses connection and gets lost. So far, there are no corresponding solutions to effectively deal with a UAV malfunction or a UAV disconnection.

### SUMMARY OF THE DISCLOSURE

One aspect of the present disclosure provides a troubleshooting method. The troubleshooting method includes receiving a locking instruction instructing to lock a target aircraft and locking the target aircraft according to the locking instruction.

Another aspect of the present disclosure provides an aircraft. The aircraft includes a transceiver configured to receive a locking instruction for locking the aircraft and a processor configured to lock the aircraft according to the locking instruction.

### BRIEF DESCRIPTION OF THE DRAWINGS

FIG. 1 illustrates a schematic structural diagram of an exemplary UAV system consistent with disclosed embodiments.

FIG. 2 illustrates a flowchart of an exemplary troubleshooting method consistent with disclosed embodiments.

FIG. 3 illustrates a flowchart of another exemplary troubleshooting method consistent with disclosed embodiments.

FIG. 4 illustrates a schematic block diagram of an exemplary aircraft consistent with disclosed embodiments.

FIG. 5 illustrates a schematic block diagram of another exemplary aircraft consistent with disclosed embodiments.

FIG. 6 illustrates a schematic block diagram of an exemplary server consistent with disclosed embodiments.

FIG. 7 illustrates a schematic block diagram of another exemplary server consistent with disclosed embodiments.

FIG. 8 illustrates a schematic block diagram of an exemplary control device consistent with disclosed embodiments.

FIG. 9 illustrates a schematic block diagram of another exemplary control device consistent with disclosed embodiments.

FIG. 10 illustrates a schematic block diagram of another exemplary aircraft consistent with disclosed embodiments.

FIG. 11 illustrates a schematic block diagram of another exemplary control device consistent with disclosed embodiments.

### DETAILED DESCRIPTION

Reference will now be made in detail to exemplary embodiments of the disclosure, which are illustrated in the accompanying drawings. Hereinafter, embodiments consistent with the disclosure will be described with reference to drawings. Wherever possible, the same reference numbers will be used throughout the drawings to refer to the same or like parts. The described embodiments are some but not all of the embodiments of the present disclosure. Based on the disclosed embodiments, persons of ordinary skill in the art may derive other embodiments consistent with the present disclosure, all of which are within the scope of the present disclosure. Further, in the present disclosure, the disclosed embodiments and the features of the disclosed embodiments may be combined under conditions without conflicts.

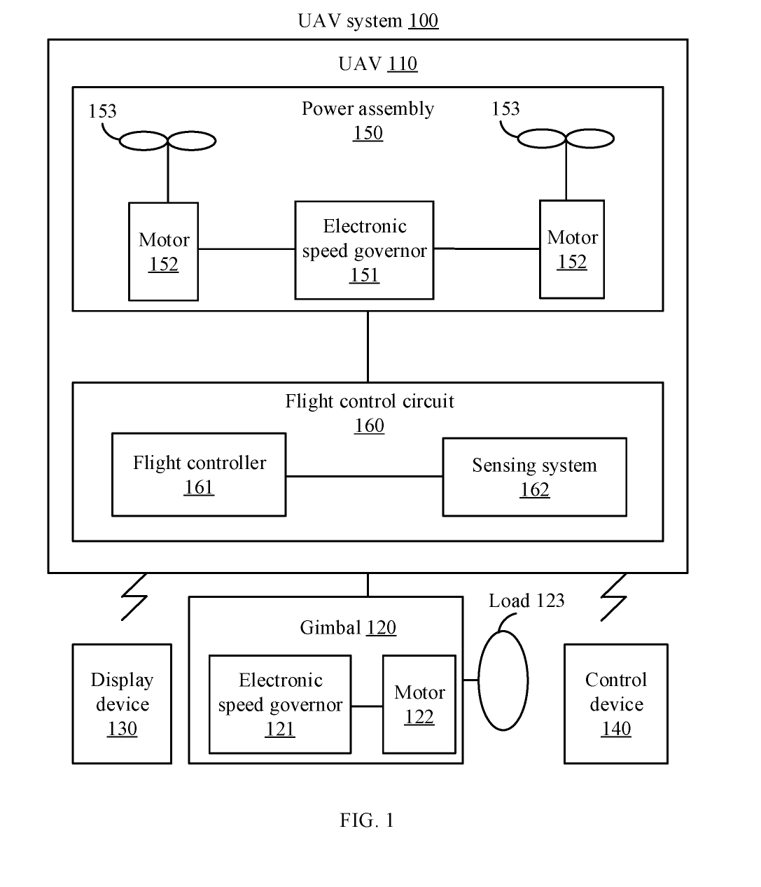

FIG. 1 illustrates a schematic structural diagram of an exemplary UAV system 100 consistent with disclosed embodiments. The following embodiments will take a rotorcraft as an example for illustration.

As shown in FIG. 1, the UAV system 100 includes a UAV 110, a gimbal 120, a display device 130, and a control device 140. The UAV 110 includes a power assembly 150 and a flight control circuit 160. The UAV 110 can wirelessly communicate with the control device 140 and the display device 130.

The UAV 110 may include a body frame. The body frame may include a main body and a foot stand (i.e., a landing gear). The main body may include a central frame, and one or more arms connected with the central frame. The one or more arms may extend radially from the central frame. The foot stand may be connected to the main body for supporting the UAV 110 when the UAV 110 lands.

As shown in FIG. 1, the power assembly 150 includes an electronic speed governor (ESG) 151, one or more rotors 153, and one or more motors 152 corresponding to the one or more rotors 153. The one or more motors 152 are connected to the ESG 151 and the one or more rotors 153. The one or more motors 152 and the rotors 152 may be arranged on the corresponding arm. The ESG 151 receives a driving signal generated by a flight control circuit 160, and applies a driving current to the one or more motors 152 for controlling a rotation speed of the one or more motors 152 according to the driving signal. The one or more motors 152 drive the one or more rotors 153 to rotate for supplying a flight power to the UAV 110, which allows the UAV 110 to achieve one or more degrees of freedom of motion. In some embodiments, the UAV 110 may rotate around one or more axes of rotation. For example, the above axes of rotation may include a roll axis, a yaw axis, and a pitch axis. The motor 152 may be a DC motor or an AC motor. Moreover, the motor 152 may be a brushless motor or a brush motor.

As shown in FIG. 1, the flight control circuit 160 includes a flight controller 161 and a sensing system 162. The sensing system 162 may measure attitude of the UAV, e.g., position and status of the UAV in the space, such as a three-dimensional position, a three-dimensional angle, a three-dimensional speed, a three-dimensional acceleration, and/or a three-dimensional angular speed. The sensing system 162 may include at least one of the following sensors: a gyroscope, an electronic compass, an inertial measurement unit (IMU), a vision sensor, a global positioning system (GPS), and a barometer, etc. The GPS and the barometer can measure data for positioning the aircraft, therefore the GPS and/or the barometer may be regarded as a positioner (positioning device). The flight controller 161 controls the flight of the UAV 110. For example, the flight controller 161 may control the flight of the UAV 110 according to the attitude measured by the sensing system 162. The flight controller 161 can control the UAV 110 according to a preprogrammed instruction, or can control the UAV 110 by responding to one or more instructions from the control device 140.

As shown in FIG. 1, the gimbal 120 includes an ESG 121 and a motor 122. The gimbal 120 carries a load 123. In some embodiments, the load 123 may include a camera, such as a photo camera and a video camera, which is not limited herein. In some embodiments, the gimbal 120 may carry a weapon or equipment for carrying other loads. The flight controller 161 controls the motion of the gimbal 120 via the ESG 121 and the motor 122. In some other embodiments, the gimbal 120 may also include a control circuit for controlling the motion of the gimbal 120 by controlling the ESG 121 and the motor 122. The gimbal 120 may be independent of the UAV 110, or may be part of the UAV 110. The motor 122 may be a DC motor or an AC motor. Moreover, the motor 122 may be a brushless motor or a brush motor. The gimbal 120 may be arranged at the top of the aircraft or at the bottom of the aircraft.

The display device 130 may be arranged at a ground terminal of the UAV system 100, and may wirelessly communicate with the UAV 110 and display the attitude of the UAV 110. Moreover, if the load 123 is a shooting device, pictures taken by the shooting device may be displayed on the display device 130. The device 130 may be a standalone device or may be arranged in the control device 140.

The control device 140 may be arranged at the ground terminal of the UAV system 100, and may wirelessly communicate with the UAV 110 for remote control of the UAV 110. In some embodiments, the control device 140 may be a remote controller or a terminal device installed with an application (APP) that can control the UAV, e.g., a smart phone, a tablet computer, etc. In some embodiments, a user's input received by the control device 140 may refer to the control of the UAV by an input device on the remote controller, such as a pull wheel, a button, a key, a joystick, or by a user interface on the terminal device.

Terminology of each component of the above UAV system is intended for identification and should not be interpreted as a limitation to the present disclosure.

UAV malfunctions may include the following cases: (a) UAV explosion, and the UAV and the control device are disconnected. (b) UAV explosion, and the UAV and the control device are still connected. (c) UAV non-explosion, and the UAV and the control device are disconnected. (d) UAV non-explosion, and the UAV and the control device are still connected.

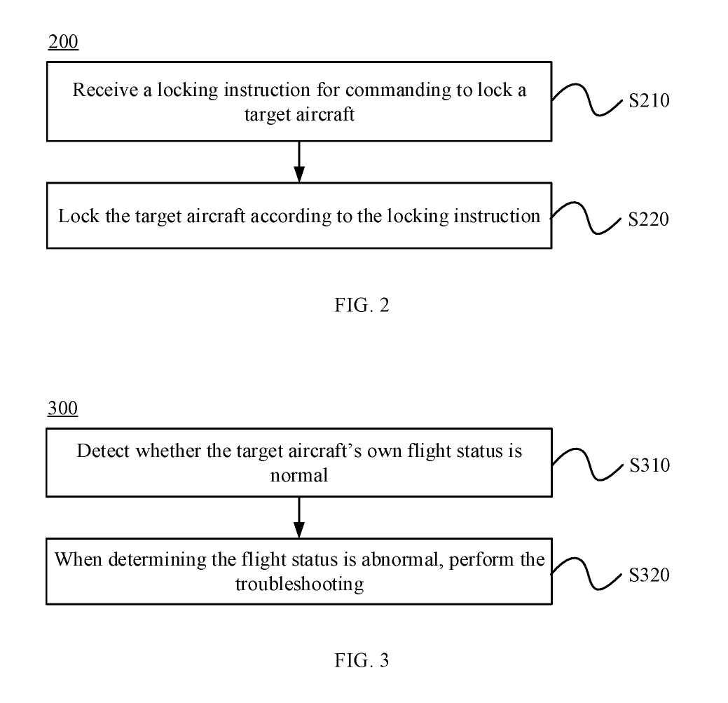

In some embodiments, the present disclosure provides a troubleshooting method. FIG. 2 illustrates a flowchart of an exemplary troubleshooting method consistent with disclosed embodiments. From the point of view of a malfunctioning aircraft, which is referred to as a target aircraft herein, as shown in FIG. 2, the troubleshooting method 200 includes the target aircraft receiving a locking instruction for commanding to lock the target aircraft (S210), and the target aircraft locking the target aircraft according to the locking instruction (S220).

In some embodiments, the locking instruction may be sent by the user via the control device, or by an aircraft manufacturer via a server after the user contacts the aircraft manufacturer, which is not limited herein.

Consistent with the troubleshooting method of the present disclosure, the action of locking may be performed when the target aircraft receives the locking instruction. As such, the target aircraft cannot be activated by an illegal user when the target aircraft malfunctions.

In some embodiments, as shown in FIG. 2, the target aircraft locks the target aircraft according to the locking instruction (S220). According to the locking instruction, what the target aircraft can lock may include one or more of a flight control circuit, a gimbal, a motor, a camera, a positioner, a power assembly, and an ESG. A flight control circuit, a gimbal, a motor, a camera, a positioner, a power assembly, and an ESG may respectively correspond to the corresponding parts described above in connection with FIG. 1 or the corresponding parts mentioned above. The circuits or devices that can be locked by the target aircraft may include, but are not limit to, the abovementioned circuits or devices.

In some embodiments, each circuit or device of the target aircraft may be configured with a lock interface. At least one of the above circuits or devices may be locked by the lock interface. The lock interface may be a circuit inside the target aircraft and may be realized by software and/or hardware, which is not limited herein. When the target aircraft receives the locking instruction, each circuit or device may lock its own functions, thereby ensuring that the illegal user cannot start the target aircraft without being unlocked. After the legal user performs the action of unlocking, each circuit or device can restore its own functions.

In some embodiments, as shown in FIG. 2, the target aircraft receives a locking instruction for commanding to lock the target aircraft (S210). What the target aircraft can receive may include the locking instruction transmitted from the server. That is, the locking instruction may be transmitted from the server.

In some embodiments, when the target aircraft loses connection or malfunctions and cannot keep flying, by controlling the control device of the target aircraft, such as a mobile-phone APP, a wristband, a remote controller, glasses, a computer, the user may send a loss report to the server of the aircraft manufacturer, requesting to lock the target aircraft, and the server may send the locking instruction after receiving the loss report. In some embodiments, the user may request locking the target aircraft from customer service of the aircraft manufacturer through contacting the customer service by phone or the like, and a customer service staff may operate the server to send the locking instruction. In some embodiments, when the target aircraft detects that the target aircraft's own flight status is abnormal, the target aircraft may transmit the loss report that requests to lock the target aircraft.

Correspondingly, the server may acquire the loss report that requests to lock the target aircraft. The server may send the locking instruction to the target aircraft in accordance with the loss report. In some embodiments, acquiring the loss report by the server may include receiving the loss report sent by the user via the control device. In some other embodiments, acquiring the loss report by the server may include receiving the loss report, inputted by a service staff via a service interface.

In some embodiments, loss report and the locking instruction may include an identification identifying the target aircraft, which will be described in detail below.

In some embodiments, the target aircraft consistent with the present disclosure may include a first communicator (first communication circuit) that communicates with the server through a network having an authorized frequency band for sending or receiving the locking instruction. For example, the first communicator may support one or more communication systems, such as a long-term-evolution (LTE) system, a universal-mobile-telecommunications system (UMTS), a global system for mobile communication (GSM) system, a public land mobile network (PLMN) system, a code division multiple access (CDMA) system, a wideband code division multiple access (WCDMA) system, an upcoming 5G communication system, and communication systems after 5G.

Moreover, when the control device, e.g., the remote controller, can communicate with the server and the remote controller includes a communicator similar to the first communicator, the user may also request the server of the aircraft manufacturer to lock the target aircraft via the remote controller or the APP installed in the remote controller, which is not limited herein.

In some other embodiments, the locking instruction received by the target aircraft at S210 may include the locking instruction transmitted from the control device. That is, the locking instruction may be used to control the device.

In some embodiments, when the target aircraft malfunctions and cannot keep flying but can maintain communication with the control device, the user may send the locking instruction to the target aircraft via the control device.

In some embodiments, before the target aircraft receives the locking instruction transmitted by the control device, the control device may acquire the loss report that requests to lock the target aircraft. The control device may transmit the locking instruction to the target aircraft in accordance with the loss report. The locking instruction may command to lock the target aircraft. In some embodiments, when the target aircraft loses connection or malfunctions and cannot keep flying, the loss report may be generated when the user taps an icon or depresses a button of the control device, etc. For example, the control device may be a mobile-phone APP, a wristband, a remote controller, glasses, or a computer, etc. In some embodiments, when the target aircraft detects that the target aircraft's own flight status is abnormal, the target aircraft may transmit the loss report to the control device, requesting to lock the target aircraft.

In some embodiments, the target aircraft consistent with the present disclosure may include a second communicator (second communication circuit) that communicates with the control device via an unauthorized frequency band for sending or receiving the locking instruction. The link of the unauthorized frequency band may be a wireless link between the target aircraft and the control device. The control device may be a remote controller that can communicate with the target aircraft via the wireless link. In some embodiments, the control device may be a smart wearable device, which has similar functions to the remote controller and can communicate with the target aircraft, such as a wristband and glasses. In some embodiments, the control device may be a mobile communication device, such as a mobile phone. The mobile phone may control the target aircraft through the APP, which is not limited herein.

In some embodiments, the unauthorized frequency band may be a 2.4 GHz band and/or a 5.8 GHz band, which is not limited herein.

In some embodiments, the locking instruction may include first identification information identifying the to-be-locked aircraft. The method 200 may also include, before the target aircraft locks itself according to the locking instruction (S220), the target aircraft determining that the aircraft corresponding to the first identification is itself. That is, the target aircraft determines that the first identification corresponds to the target aircraft.

In some embodiments, the first identification may be a serial number (SN). Moreover, the first identification information may also have other forms of numbers or the like that can uniquely identify the target aircraft, which is not limited herein.

In some embodiments, whether the user sends the locking instruction to the target aircraft through the server or through the control device, an SN of the target aircraft should be inputted or provided to prevent other aircrafts from being locked by mistake. Similarly, when the target aircraft receives a locking instruction, the target aircraft may first determine that the to-be-locked aircraft is itself which corresponds to the first identification and is commanded in the instruction. After determining that the first identification information corresponds to the target aircraft, the target aircraft may be locked. The first identification information may correspond to the abovementioned loss report and the identification in the locking instruction.

In some embodiments, the locking instruction may be an encrypted instruction. Correspondingly, the method 200 may also include, before the target aircraft locks itself according to the locking instruction (S220), the target aircraft decrypting the locked instruction. When the locking instruction is transmitted by the server, what the server transmits to the target aircraft in accordance with the loss report may include the encrypted locking instruction. When the locking instruction is transmitted by the control device, what the control device transmits to the target aircraft in accordance with the loss report may include the encrypted locking instruction.

In some embodiments, each aircraft may store a digital certificate. The server or the control device transmitting the locking instruction may encrypt the locking instruction. After receiving the locking instruction, the target aircraft may decrypt the locking instruction with the digital certificate. When the locking instruction is successfully decrypted with the digital certificate, the target aircraft may be locked. Thus, only the legal user can lock the target aircraft via the control device or the server, whereas the illegal user cannot lock the target aircraft at will.

In some embodiments, the locked aircraft may also be unlocked. Correspondingly, the method 200 may also include that: the target aircraft receives an unlocking instruction for commanding to unlock the target aircraft and the target aircraft unlocks the target aircraft according to the unlocking instruction.

In some embodiments, what the target aircraft receives may include the unlocking instruction transmitted by the server. Correspondingly, the server may transmit the unlocking instruction to the target aircraft.

In some embodiments, when the target aircraft is found by the legal user, or in other circumstances, the user may request the server of the aircraft manufacturer to unlock the target aircraft by controlling a mobile-phone APP of the target aircraft, a wristband, glasses, or a computer, etc. After receiving the request, the server may transmit the unlocking instruction. In some embodiments, the user may request unlocking the target aircraft from the customer service of the aircraft manufacturer through contacting the customer service by phone or the like, and the customer service staff may operate the server to transmit the unlocking instruction.

In some other embodiments, what the target aircraft receives may include the unlocking instruction transmitted by the control device. Correspondingly, the control device may transmit the unlocking instruction to the target aircraft.

In some embodiments, when the target aircraft is found by the legal user or the target aircraft can maintain communication with the control device, the user may transmit the unlocking instruction to the target aircraft via the control device.

In some embodiments, similar to the locking instruction, the unlocking instruction may include second identification information identifying the to-be-unlocked aircraft. The method 200 may also include that, before the target aircraft unlocks the target aircraft according to the unlocking instruction, the target aircraft determines that the aircraft corresponding to the second identification information is itself. In other words, the target aircraft may determine that the second identification information corresponds to the target aircraft. In some embodiments, the second identification may be an SN. In some other embodiments, the second identification information may have another form of numbers that can uniquely identify the target aircraft, which is not limited herein.

In some embodiments, whether the user sends the unlocking instruction through the server or through the control device, an SN of the target aircraft should be inputted or provided to prevent other aircrafts from being unlocked by mistake. Similarly, when receiving an unlocking instruction, the target aircraft may first determine that the to-be-unlocked aircraft corresponding to the second identification information is itself. After determining that the second identification information corresponds to the target aircraft, the target aircraft may be unlocked.

In some embodiments, similar to the locking instruction, the unlocking instruction may be an encrypted instruction. The method 200 may also include that, before the target aircraft unlocks the target aircraft according to the unlocking instruction, the target aircraft decrypts the unlocking instruction. Thus, only the legal user can unlock the target aircraft via the control device or the server, whereas the illegal user cannot unlock the target aircraft at will.

Correspondingly, when the unlocking instruction is transmitted by the server, what the server transmits to the target aircraft may include the encrypted unlocking instruction. When the unlocking instruction is transmitted by the control device, what the control device transmits to the target aircraft may include the encrypted unlocking instruction.

The foregoing loss report may also be an encrypted request. Correspondingly, the server or the control device may need to decrypt the loss report.

In some embodiments, the method 200 may also include that: the target aircraft detects whether the target aircraft's own flight status is normal; when the flight status is determined abnormal, the target aircraft transmits the locking instruction to the control device and/or the server; and the control device and/or the server transmit the locking instruction according to the locking request.

In some embodiments, it is not limited to the user or the aircraft manufacturer that can proactively lock the target aircraft. When the target aircraft crashes or explodes, the target aircraft may detect whether the target aircraft's own flight status is normal or detect whether each circuit of the target aircraft can work properly. When the flight status is determined abnormal, the target aircraft may send the locking instruction to the control device and/or the server. The locking instruction may be transmitted by the control device and/or the server according to the locking request. When finding itself abnormal, the target aircraft may remind the user to lock the target aircraft via the APP or the remote controller, or may remind the user to contact the aircraft manufacturer for locking the target aircraft.

In some embodiments, the method 200 may also include that, after the target aircraft receives the locking instruction (S210), the target aircraft acquires information of a first position where the target aircraft is present via the positioner, and the target aircraft transmits the information of the first position to the control device via the wireless link between the target aircraft and the control device.

In some embodiments, the positioner may have a Global Positioning System (GPS) function and/or a Beidou positioning function, or have a positioning function of other technologies, which can be realized by software and/or hardware and is not limited herein. The target aircraft may acquire the information of the first position where the target aircraft is present via the positioner, and may transmit the information of the first position to the control device via the wireless link between the target aircraft and the control device.

Correspondingly, the control device may receive information of a first position where the target aircraft is present, transmitted by the target aircraft via the wireless link between the control device and the target aircraft, may determine information of a second position where the control device is present, may determine navigation between the control device and the target aircraft, according to the information of the first position and the information of the second position, and may output the navigation. In some embodiments, the control device may generate an appropriate path to search for the target aircraft, according to the information of the first position and the information of the second position where the control device is present, in connection with a map that can be configured in the control device (i.e., the control device may determine the navigation between the control device and the target aircraft), and may navigate the user by outputs of pictures and/or voices, thus helping the user search for the target aircraft.

In some embodiments, before receiving the information of the first position where the target aircraft is present transmitted by the target aircraft, via the wireless link between the control device and the target aircraft, the control device may also transmit a positioning request to the target aircraft. The positioning request may request the information of the first position where the target aircraft is present. After receiving the positioning request, the target aircraft may perform the action of positioning and transmit the information of the first position to the control device.

In some embodiments, the method 200 may also include that, after the target aircraft receives the locking instruction (S210), the target aircraft sounds an alarm or sets off a warning light.

In some embodiments, if the target aircraft loses connection with the control device and detects itself abnormal, the target aircraft may sound the alarm or set off the warning light to help the user search for the target aircraft. Moreover, if the target aircraft remains connected to the control device, the user may make the target aircraft sound an alarm and/or set off a warning light, by clicking the icon of the APP on the control device (e.g., a mobile phone or a remote controller) or depressing the button on the remote controller. The alarm sound may be emitted by an electronic adjustment circuit or a speaker, and the warning light may be emitted by a light-emitting diode (LED). The alarm sound and/or the warning light may also be produced by other software or hardware, which is not limited herein.

The present disclosure also provides another troubleshooting method. FIG. 3 illustrates a flowchart of another exemplary troubleshooting method consistent with disclosed embodiments. The method 300 is executed by the target aircraft. As shown in FIG. 3, the method 300 includes the target aircraft detecting whether the target aircraft's own flight status is normal (S310), and, when the flight status is determined abnormal, the target aircraft performing the troubleshooting (S320).

At S320, performing the troubleshooting may include at least one of: the target aircraft transmitting the position where the target aircraft is present to the control device, the target aircraft locking itself automatically, the target aircraft sounding the alarm, or the target aircraft setting off the warning light, etc.

Consistent with the troubleshooting method of the present disclosure, the troubleshooting may be performed when the target aircraft detects that the target aircraft's own flight status is abnormal, which allows the target aircraft to proactively take measures when the target aircraft malfunctions for lowering the user's loss as much as possible.

In some embodiments, at S310, detecting the target aircraft's own flight status may include detecting whether propellers are working properly, temperature of the motor is normal, etc. For example, if the propellers do not rotate, rotation of the propellers is constrained, or the temperature of the motor is too high, etc., the flight status of the target aircraft may be determined to be abnormal.

In some embodiments, performing the troubleshooting (S320) may include: the target aircraft acquiring the position where the target aircraft is present via the positioner, and/or the target aircraft transmitting the position to the control device via the wireless link between the target aircraft and the control device. Correspondingly, the control device may receive the information of the first position where the target aircraft is present transmitted by the target aircraft via the wireless link between the control device and the target aircraft, may determine the information of the second position where the control device is present, may determine the navigation between the control device and the target aircraft according to the information of the first position and the information of the second position, and may output the navigation.

In some embodiments, before receiving the position where the target aircraft is present transmitted by the target aircraft via the wireless link between the control device and the target aircraft, the control device may also transmit the positioning request to the target aircraft. The positioning request may ask for the position where the target aircraft is present.

In some embodiments, performing the troubleshooting (S320) may include locking the target aircraft automatically. Locking the target aircraft automatically may include locking one or more of flight control circuit, the gimbal, the motor, the camera, the positioner, the power assembly, and the electronic speed governor.

The method 300 may also include, after the target aircraft is locked, receiving the unlocking instruction for commanding to unlock the target aircraft, and unlocking the target aircraft according to the unlocking instruction. The unlocking instruction may include the identification identifying the to-be-unlocked aircraft. The method may also include that, before the target aircraft unlocks the target aircraft according to the unlocking instruction, the target aircraft determines that the target aircraft corresponding to the identification is itself. In other words, the target aircraft may determine that the identification corresponds to the target aircraft. The identification may be an SN.

The unlocking instruction may be transmitted by the server or the control device. Correspondingly, the target aircraft receiving the unlocking instruction may include that the target aircraft receives the unlocking instruction transmitted by the server. In some embodiments, the target aircraft receiving the unlocking instruction may include that the target aircraft receives the unlocking instruction transmitted by the control device. Correspondingly, the control device may transmit the unlocking instruction to the target aircraft for commanding to unlock the target aircraft. In some embodiments, the unlocking instruction may be encrypted. That is, the control device may transmit the encrypted unlocking instruction to the target aircraft. The method 300 may also include, before the target aircraft unlocks the target aircraft according to the unlocking instruction, decrypting the unlocking instruction.

In some embodiments, performing the troubleshooting (S320) may include sounding an alarm and/or setting off a warning light. Correspondingly, after outputting the navigation, the control device may also transmit an alarm instruction to the target aircraft for commanding the target aircraft to sound an alarm and/or set off a warning light.

In some embodiments, the method 300 may also include, before the target aircraft sounds the alarm and/or sets off the warning light, receiving the alarm instruction transmitted by the control device.

In some embodiments, the control device may be a remote controller, a smart wearable device, or a mobile communication device which are capable of communicating with the target aircraft through the wireless link.

The troubleshooting methods consistent with the present disclosure have been described above in detail. The following will set forth the target aircraft, the server and the control device consistent with the present disclosure.

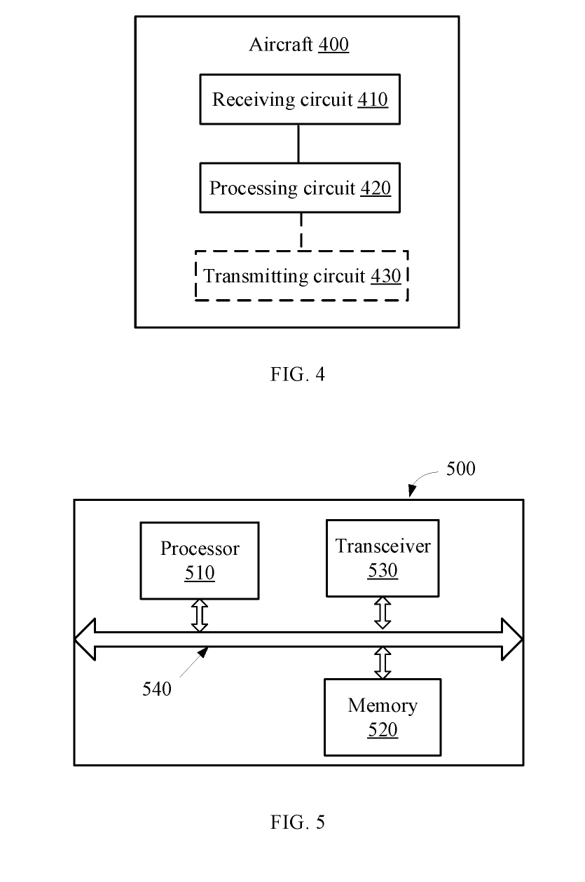

FIG. 4 illustrates a schematic block diagram of an exemplary aircraft 400 consistent with disclosed embodiments. The aircraft 400 can be the target aircraft. As shown in FIG. 4, the aircraft 400 includes a receiving circuit 410 configured to receive the locking instruction that commands to lock the aircraft 400 and a processing circuit 420 configured to lock the aircraft 400 according to the locking instruction.

The aircraft consistent with the present disclosure may be locked when receiving the locking instruction, which prevents the aircraft from being activated by an illegal user when the aircraft malfunctions.

In some embodiments, according to the locking instruction, the processing circuit 420 may lock at least one of a flight control circuit, a gimbal, a motor, a camera, a positioner, a power assembly, or an ESG of the target aircraft.

In some embodiments, the locking instruction may include the first identification information identifying the to-be-locked aircraft, and the processing circuit 420 may also determine that the first identification information corresponds to the target aircraft, before locking the target aircraft according to the locking instruction.

In some embodiments, the receiving circuit 410 may receive the locking instruction transmitted by the server.

In some embodiments, the receiving circuit 410 may receive the locking instruction transmitted by the control device.

In some embodiments, the locking instruction may be encrypted, and the processing circuit 420 may also decrypt the locking instruction before locking the target aircraft according to the locking instruction.

In some embodiments, the receiving circuit 410 may receive the unlocking instruction for commanding to unlock the target aircraft; and the processing circuit 420 may also unlock the target aircraft according to the unlocking instruction.

In some embodiments, the unlocking instruction may include the second identification information identifying the to-be-unlocked aircraft. The processing circuit 420 may also determine that the second identification information corresponds to the target aircraft, before unlocking the target aircraft according to the unlocking instruction.

In some embodiments, the receiving circuit 410 may receive the unlocking instruction transmitted by the server.

In some embodiments, the receiving circuit 410 may receive the unlocking instruction transmitted by the control device.

In some embodiments, the unlocking instruction may be encrypted, and the processing circuit 420 may decrypt the unlocking instruction before the target aircraft is unlocked according to the unlocking instruction.

In some embodiments, the first identification and the second identification may be SNs.

In some embodiments, the processing circuit 420 may also detect whether the flight status of the aircraft 400 is normal. In these embodiments, as shown in FIG. 4, the aircraft 400 further includes a transmitting circuit 430 configured to transmit the locking request to the control device and/or the server when the processing circuit 420 determines the flight status is abnormal. The locking instruction may be transmitted by the control device and/or the server according to the locking request.

In some embodiments, the processing circuit 420 may also acquire the information of the first position where the target aircraft is present via the positioner, after the receiving circuit 410 receives the locking instruction.

In some embodiments, the control device may be a remote controller, a smart wearable device, or a mobile communication device which are capable of communicating with the target aircraft through the wireless link.

In some embodiments, the processing circuit 420 may also sound an alarm and/or set off a warning light after the receiving circuit 410 receives the locking instruction.

In some embodiments, the receiving circuit 410 and the transmitting circuit 430 may be include a transceiver, and the processing circuit 420 may include a processor. FIG. 5 illustrates a schematic block diagram of another exemplary aircraft 500 consistent with disclosed embodiments. As shown in FIG. 5, the aircraft 500 includes a processor 510 and a transceiver 530. The aircraft 500 also includes a memory 520. The memory 520 may store instructions, and the processor 510 and the transceiver 530 may execute the instructions stored in the memory 520.

The components of the aircraft 500 may be connected together by a bus system 540. In addition to a data bus, the bus system 540 may also include a power bus, a control bus, and a status-signal bus.

The transceiver 530 may receive the locking instruction for commanding to lock the target aircraft.

The processor 510 may lock the target aircraft according to the locking instruction.

The target aircraft consistent with the present disclosure may be locked when receiving the locking instruction, which prevents the target aircraft from being activated by an illegal user when the target aircraft malfunctions.

In some embodiments, the foregoing methods consistent with the present disclosure can be applied to the processor, or can be realized by the processor. The processor may be an integrated-circuit chip with a capability of processing signals. In implementation, in some embodiments, each process of the foregoing methods consistent with the present disclosure may be completed by hardware (e.g., integrated logic circuits) in the processor or by software (e.g., instructions). The foregoing processor may be a general processor, a digital signal processor (DSP), an application specific integrated circuit (ASIC), a field programmable gate array, or other programmable logic devices, discrete gate or transistor logic devices, discrete hardware components, which can implement or execute the methods, processes, and logic blocks consistent with the present disclosure. The general processor may be a microprocessor, or the processor may be any conventional processor and the like. The processes of the methods consistent with the present disclosure may be completed by hardware coupled to a decoding processor, or may be completed by a combination of hardware and software coupled to the decoding processor. The software may be stored in a storage medium, such as a random-access memory, flash memory, read-only memory, programmable read-only memory or electrically erasable/programmable memory, registers, etc. The storage medium may be coupled to the memory, and the processor may read information in the memory and complete the processes of the foregoing methods in connection with the processor's hardware.

It can be understood that the memory consistent with the present disclosure may be a volatile memory or a non-volatile memory, or may include both volatile and non-volatile memories. The non-volatile memory may be a read-only memory (ROM), a programmable read-only memory (PROM), an erasable/programmable read-only memory (EPROM), an electrically erasable/programmable read-only memory (i.e., electrically EPROM, EEPROM), or a flash memory. The volatile memory may be a random-access memory (RAM) serving as an external high-speed cache. By illustrative but non-limited description, many forms of RAM may be used, such as a static RAM (SRAM), a dynamic RAM (DRAM), a synchronous DRAM (SDRAM), a double data rate SDRAM (DDR-SDRAM), an enhanced SDRAM (ESDRAM), a synclink DRAM (SLDRAM), and a direct rambus RAM (DRRAM). The memory of systems and methods consistent with the present disclosure is intended to include, but is not limited to, one of these and any other appropriate types of memories.

In some embodiments, according to the locking instruction, the processor 510 may lock one or more of a flight control circuit, a gimbal, a motor, a camera, a positioner, a power assembly, and an ESG of the target aircraft.

In some embodiments, the locking instruction may include the first identification information identifying the to-be-locked aircraft, and the processor 510 may also determine that the first identification information corresponds to the target aircraft, before the target aircraft is locked according to the locking instruction.

In some embodiments, the transceiver 530 may receive the locking instruction transmitted by the server.

In some embodiments, the transceiver 530 may receive the locking instruction transmitted by the control device.

In some embodiments, the locking instruction may be encrypted, and the processor 510 may also decrypt the locking instruction before the target aircraft is locked according to the locking instruction.

In some embodiments, the transceiver 530 may also receive the unlocking instruction for commanding to unlock the target aircraft, and the processor 510 may also unlock the target aircraft according to the unlocking instruction.

In some embodiments, the unlocking instruction may include the second identification information identifying the to-be-unlocked aircraft. The processor 510 may also determine that the second identification information corresponds to the target aircraft, before the target aircraft is unlocked according to the unlocking instruction.

In some embodiments, the transceiver 530 may receive the unlocking instruction transmitted by the server.

In some embodiments, the transceiver 530 may receive the unlocking instruction transmitted by the control device.

In some embodiments, the unlocking instruction may be encrypted, and the processor 510 may also decrypt the unlocking instruction before the target aircraft is unlocked according to the unlocking instruction.

In some embodiments, the first identification or the second identification may be SNs.

In some embodiments, the processor 510 may also detect whether the flight status of the aircraft 500 is normal. The transceiver 530 may also transmit the locking request to the control device and/or the server, when the flight status is determined abnormal. The locking instruction may be transmitted by the control device and/or the server according to the locking request.

In some embodiments, after the transceiver 530 receives the locking instruction, the processor 510 may also acquire the information of the first position where the target aircraft is present. The transceiver 530 may also transmit the information of the first position to the control device through the wireless link between the aircraft 500 and the control device.

In some embodiments, the control device may be a remote controller, a smart wearable device, or a mobile communication device which are capable of communicating with the target aircraft through the wireless link.

In some embodiments, the processor 510 may also sound an alarm and/or set off a warning light after the transceiver 530 receives the locking instruction.

The aircraft 400 in FIG. 4 or the aircraft 500 in FIG. 5 can perform each process described in the foregoing embodiments in connection with FIGS. 1 to 3. To avoid repetition, details are not described herein again.

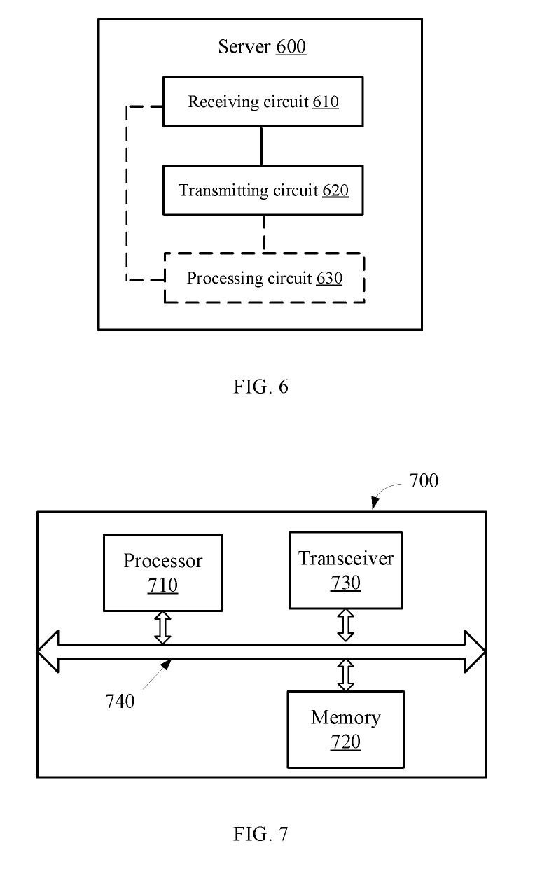

FIG. 6 illustrates a schematic block diagram of an exemplary server 600 consistent with disclosed embodiments. As shown in FIG. 6, the server 600 includes a receiving circuit 610 configured to receive the loss report that request to lock the target aircraft, and a transmitting circuit 620 configured to transmit the locking instruction to the target aircraft in accordance with the loss report. The locking instruction may command to lock the target aircraft.

In some embodiments, the locking instruction may lock one or more of a flight control circuit, a gimbal, a motor, a camera, a positioner, a power assembly, and an ESG of the target aircraft.

In some embodiments, the loss report and the locking instruction may include the identification for identifying the target aircraft.

In some embodiments, the receiving circuit 610 may receive the loss report sent by the user via the control device.

In some embodiments, the control device may be a remote controller, a smart wearable device or a mobile communication device, which is capable of communicating with the target aircraft through the wireless link.

In some embodiments, the receiving circuit 610 may receive the loss report inputted by a service staff through a service interface.

In some embodiments, the loss report may be encrypted, and in these embodiments, as shown in FIG. 6, the server 600 further includes a processing circuit 630 configured to decrypt the loss report.

In some embodiments, the transmitting circuit 620 may transmit the encrypted locking instruction to the target aircraft in accordance with the loss report.

In some embodiments, the transmitting circuit 620 may also transmit the unlocking instruction to the target aircraft for commanding to unlock the target aircraft.

In some embodiments, the transmitting circuit 620 may transmit the encrypted unlocking instruction to the target aircraft.

In some embodiments, the unlocking instruction may include the identification identifying the to-be-unlocked aircraft.

In some embodiments, the identification may be an SN.

In some embodiments, the receiving circuit 610 and the transmitting circuit 620 may include a transceiver. FIG. 7 illustrates a schematic block diagram of another exemplary server 700 consistent with disclosed embodiments. As shown in FIG. 7, the server 700 includes a transceiver 730. The server 700 also includes a processor 710 and a memory 720. The memory 720 may store instructions, and the processor 710 and the transceiver 730 may execute the instructions stored in the memory 720. The processing circuit 630 may be implemented by the processor 710.

The components of the server 700 may be connected together by a bus system 740. In addition to a data bus, the bus system 740 may also include a power bus, a control bus, and a status-signal bus.

The transceiver 730 may acquire the loss report that requests to lock the target aircraft.

The transceiver 730 may also send the locking instruction to the target aircraft in accordance with the loss report, and the locking instruction may command to lock the target aircraft.

In some embodiments, the locking instruction may lock one or more of a flight control circuit, a gimbal, a motor, a camera, a positioner, a power assembly, and an ESG of the target aircraft.

In some embodiments, the loss report and the locking instruction may include the identification identifying the target aircraft.

In some embodiments, the transceiver 730 may receive the loss report sent by the user through the control device.

In some embodiments, the control device may be a remote controller, a smart wearable device or a mobile communication device, which is capable of communicating with the target aircraft through the wireless link.

In some embodiments, the transceiver 730 may receive the loss report inputted by the service staff through the service interface.

In some embodiments, the loss report may be encrypted, and the processor 710 may decrypt the loss report.

In some embodiments, the transceiver 730 may transmit the encrypted locking instruction to the target aircraft in accordance with the loss report.

In some embodiments, the transceiver 730 may also transmit the unlocking instruction to the target aircraft for commanding to unlock the target aircraft.

In some embodiments, the transceiver 730 may transmit the encrypted unlocking instruction to the target aircraft.

In some embodiments, the unlocking instruction may include the identification identifying the to-be-unlocked aircraft.

In some embodiments, the identification may be an SN.

The server 600 in FIG. 6 or the server 700 in FIG. 7 can perform each process described in the foregoing embodiments in connection with FIGS. 1 to 3. To avoid repetition, details are not described herein again.

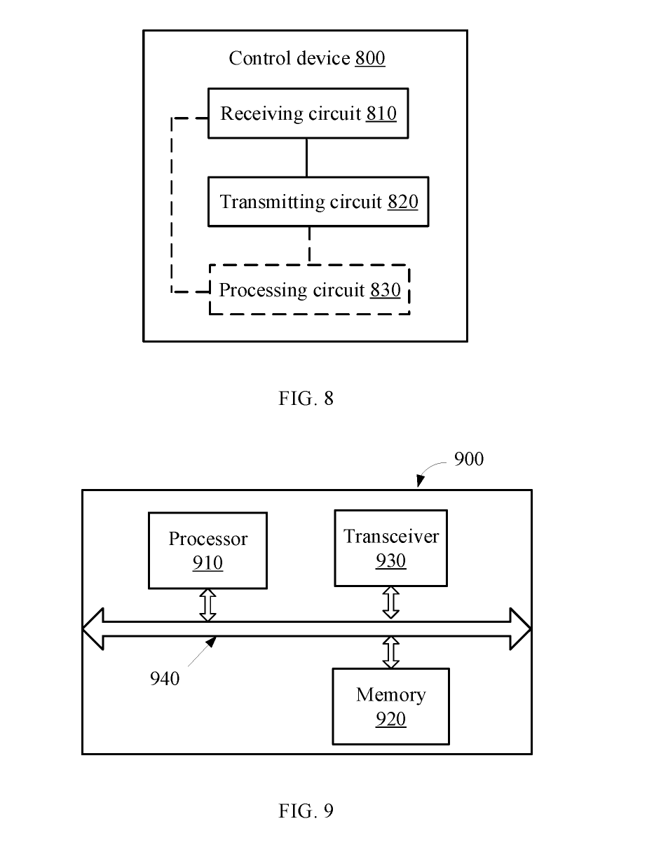

FIG. 8 illustrates a schematic block diagram of an exemplary control device 800 consistent with disclosed embodiments. As shown in FIG. 8, the control device 800 includes a receiving circuit 810 configured to receive the loss report that requests to lock the target aircraft, and a transmitting circuit 820 configured to transmit the locking instruction to the target aircraft in accordance with the loss report. The locking instruction may command to lock the target aircraft.

In some embodiments, the locking instruction may lock one or more of a flight control circuit, a gimbal, a motor, a camera, a positioner, a power assembly, and an ESG of the target aircraft.

In some embodiments, the loss report and the locking instruction may include the identification identifying the target aircraft.

In some embodiments, the loss report may be encrypted, and in these embodiments, as shown in FIG. 8, the server 800 further includes a processing circuit 830 configured to decrypt the loss report.

In some embodiments, the transmitting circuit 820 may transmit the encrypted locking instruction to the target aircraft in accordance with the loss report.

In some embodiments, the transmitting circuit 820 may also transmit the unlocking instruction to the target aircraft for commanding to unlock the target aircraft.

In some embodiments, the transmitting circuit 820 may transmit the encrypted unlocking instruction to the target aircraft.

In some embodiments, the unlocking instruction may include the identification identifying the to-be-unlocked aircraft.

In some embodiments, the identification may be an SN.

In some embodiments, the receiving circuit 810 may also receive the information of the first position where the target aircraft is present transmitted by the target aircraft through the wireless link between the control device and the target aircraft. The control device 800 may also include a processing circuit 830 for determining the information of the second position where the control device is present, determining the navigation between the control device and the target aircraft according to the information of the first position and the information of the second position, and outputting the navigation.

In some embodiments, the control device may be a remote controller, a smart wearable device or a mobile communication device, which is capable of communicating with the target aircraft through the wireless link.

In some embodiments, the receiving circuit 810 and the transmitting circuit 820 consistent with the present disclosure may include a transceiver. FIG. 9 illustrates a schematic block diagram of another exemplary control device 900 consistent with disclosed embodiments. As shown in FIG. 9, the control device 900 includes a transceiver 930. The control device 900 also includes a processor 910 and a memory 920. The memory 920 may store instructions, and the processor 910 and the transceiver 930 may execute the instructions stored in the memory 920. The processing circuit 830 may be realized by the processor 910.

The components of the server 900 may be connected together by a bus system 940. In addition to a data bus, the bus system 940 may also include a power bus, a control bus, and a status-signal bus.

The transceiver 930 may acquire the loss report that requests to lock the target aircraft.

The transceiver 930 may also send the locking instruction to the target aircraft in accordance with the loss report, and the locking instruction may command to lock the target aircraft.

In some embodiments, the locking instruction may lock one or more of a flight control circuit, a gimbal, a motor, a camera, a positioner, a power assembly, and an ESG of the target aircraft.

In some embodiments, the loss report and the locking instruction may include the identification identifying the target aircraft.

In some embodiments, the loss report may be encrypted, and the processor 910 may decrypt the loss report.

In some embodiments, the transceiver 930 may transmit the encrypted locking instruction to the target aircraft in accordance with the loss report.

In some embodiments, the transceiver 930 may also transmit the unlocking instruction to the target aircraft for commanding to unlock the target aircraft.

In some embodiments, the transceiver 930 may transmit the encrypted unlocking instruction to the target aircraft.

In some embodiments, the unlocking instruction may include the identification identifying the to-be-unlocked aircraft.

In some embodiments, the identification may be an SN.

In some embodiments, the transceiver 930 may also receive the information of the first position where the target aircraft is present transmitted by the target aircraft through the wireless link between the control device and the target aircraft. The processor 910 may determine the information of the second position where the control device is present, may determine the navigation between the control device and the target aircraft according to the information of the first position and the information of the second position, and may output the navigation.

In some embodiments, the control device may be a remote controller, a smart wearable device or a mobile communication device, which is capable of communicating with the target aircraft through the wireless link.

The control device 800 in FIG. 8 or the control device 900 in FIG. 9 can perform each process described in the foregoing embodiments in connection with FIGS. 1 to 3. To avoid repetition, details are not described herein again.

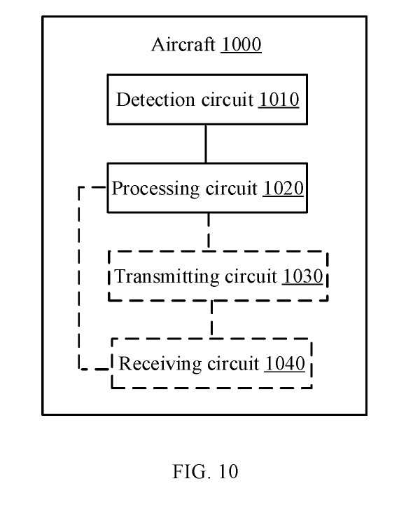

FIG. 10 illustrates a schematic block diagram of another exemplary aircraft 1000 consistent with disclosed embodiments. As shown in FIG. 10, the target aircraft 1000 includes a detection circuit 1010 configured to detect whether the flight status of the target aircraft 1000 is normal; and a processing circuit 1020 configured to perform troubleshooting when the flight status is determined to be abnormal.

The aircraft consistent with the present disclosure may perform the troubleshooting when the aircraft detects that the aircraft's own flight status is abnormal, which allows the aircraft to proactively take measures when the aircraft malfunctions for lowering the user's loss as much as possible.

In some embodiments, the processing circuit 1020 may acquire the information of the first position where the target aircraft is present via the positioner. In these embodiments, as shown in FIG. 10, the aircraft 1000 further includes a transmitting circuit 1030 configured to transmit the information of the first position to the control device, via the wireless link between the target aircraft 1000 and the control device.

In some embodiments, the processing circuit 1020 may lock the target aircraft 1000.

In some embodiments, the processing circuit 1020 may lock one or more of a flight control circuit, a gimbal, a motor, a camera, a positioner, a power assembly, and an ESG.

In some embodiments, as shown in FIG. 10, the aircraft 1000 further includes a receiving circuit 1040 configured to receive the unlocking instruction for commanding to unlock the target aircraft 1000. The processing circuit 1020 may unlock the target aircraft 1000 according to the unlocking instruction.

In some embodiments, the unlocking instruction may include the identification identifying the to-be-unlocked aircraft. The processing circuit 1020 may determine that the identification corresponds to the target aircraft according to the unlocking instruction, before the target aircraft is unlocked.

In some embodiments, the identification may be an SN.

In some embodiments, the receiving circuit 1040 may receive the unlocking instruction transmitted by the server.

In some embodiments, the receiving circuit 1040 may receive the unlocking instruction transmitted by the control device.

In some embodiments, the unlocking instruction may be encrypted. The processing circuit 1020 may decrypt the unlocking instruction according to the unlocking instruction, before the target aircraft is unlocked.

In some embodiments, the processing circuit 1020 may sound an alarm and/or set off a warning light.

In some embodiments, the receiving circuit 1040 is further configured to receive the alarm instruction transmitted by the control device, before the processing circuit 1020 sounds the alarm and/or sets off the warning light.

In some embodiments, the control device may be a remote controller, a smart wearable device or a mobile communication device, which is capable of communicating with the target aircraft through the wireless link.

In some embodiments, the detection circuit 1010 and the processing circuit 1020 consistent with the present disclosure may include one or more processors. The target aircraft may include the processor. The target aircraft may also include a memory. The memory may store instructions and the processor may execute the instructions stored in the memory. The target aircraft may also include a transceiver.

The processor may detect whether the target aircraft's own flight status is normal.

The processor may also perform troubleshooting when the flight status of the target aircraft is determined abnormal.

In some embodiments, the processor may acquire the information of the first position where the target aircraft is present. The target aircraft may also include the transceiver for transmitting the information of the first position to the control device, via the wireless link between the target aircraft and the control device.

In some embodiments, the processor may lock the target aircraft.

In some embodiments, the processor may lock one or more of a flight control circuit, a gimbal, a motor, a camera, a positioner, a power assembly, and an ESG.

In some embodiments, the target aircraft may also include the transceiver for receiving the unlocking instruction for commanding to unlock the target aircraft. The processor may also unlock the target aircraft, according to the unlocking instruction.

In some embodiments, the unlocking instruction may include the identification identifying the to-be-unlocked aircraft. The processor may also determine that the identification corresponds to the target aircraft according to the unlocking instruction, before the target aircraft is unlocked.

In some embodiments, the identification may be an SN.

In some embodiments, the transceiver may also receive the unlocking instruction transmitted by the server.

In some embodiments, the transceiver may also receive the unlocking instruction transmitted by the control device.

In some embodiments, the unlocking instruction may be encrypted. The processor may also decrypt the unlocking instruction according to the unlocking instruction, before the target aircraft is unlocked.

In some embodiments, the processor may also sound an alarm and/or set off a warning light.

In some embodiments, the target aircraft may also include the transceiver for receiving the alarm instruction transmitted by the control device, before the processor sounds the alarm and/or sets off the warning light.

In some embodiments, the control device may be a remote controller, a smart wearable device or a mobile communication device, which is capable of communicating with the target aircraft through the wireless link.

The structure of the target aircraft may be similar to the structure of the aircraft 500 in FIG. 5, which is not shown herein again. The target aircraft can perform each process described in the foregoing embodiments in connection with FIGS. 1 to 3. To avoid repetition, the details are not described herein again.

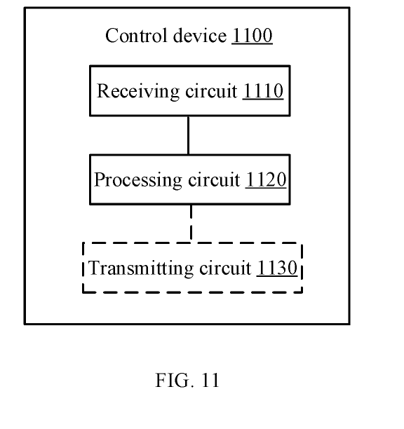

FIG. 11 illustrates a schematic block diagram of another exemplary control device 1100 consistent with disclosed embodiments. As shown in FIG. 11, the control device includes a receiving circuit 1110 configured to receive the information of the first position where the target aircraft is present transmitted by the target aircraft, via the wireless link between the control device and the target aircraft, and a processing circuit 1120 configured to determine the information of the second position where the control device is present, for determining the navigation between the control device and the target aircraft according to the information of the first position and the information of the second position, and also for outputting the navigation.

In some embodiments, as shown in FIG. 11, the control device 1100 further includes a transmitting circuit 1130 configured to transmit a positioning request to the target aircraft, before the receiving circuit 1110 receives the information of the first position where the target aircraft is present transmitted by the target aircraft, via the wireless link between the control device and the target aircraft. The positioning request may ask for the information of the first position where the target aircraft is present.

In some embodiments, the transmitting circuit 1130 is further configured to transmit the unlocking instruction to the target aircraft. The unlocking instruction may command to unlock the target aircraft.

In some embodiments, the transmitting circuit 1130 may transmit the encrypted unlocking instruction to the target aircraft.

In some embodiments, the unlocking instruction may include the identification identifying the to-be-unlocked aircraft.

In some embodiments, the identification may be an SN.

In some embodiments, the transmitting circuit 1130 is further configured to transmit the alarm instruction to the target aircraft, after the processing circuit 1120 outputs the navigation. The alarm instruction may command the target aircraft to sound an alarm and/or set off a warning light.

In some embodiments, the control device may be a remote controller, a smart wearable device or a mobile communication device, which is capable of communicating with the target aircraft through the wireless link.

In some embodiments, the receiving circuit 1110 and the transmitting circuit 1130 consistent with the present disclosure may include a transceiver. The processing circuit 1120 may include a processor. The control device may include the processor and the transceiver. The control device may also include a memory. The memory may store instructions, and the processor and the transceiver may execute the instructions stored in the memory.

The transceiver may receive the information of the first position where the target aircraft is present transmitted by the target aircraft, via the wireless link between the control device and the target aircraft.

The processor may determine the information of the second position where the control device is present.

The processor may also determine the navigation between the control device and the target aircraft according to the information of the first position and the information of the second position.

The processor may also output the navigation.

In some embodiments, the transceiver may also transmit the positioning request to the target aircraft, before receiving the information of the first position where the target aircraft is present transmitted by the target aircraft via the wireless link between the control device and the target aircraft. The positioning request may request the information of the first position where the target aircraft is present.

In some embodiments, the transceiver may also transmit the unlocking instruction to the target aircraft for commanding to unlock the target aircraft.

In some embodiments, the transceiver may transmit the encrypted unlocking instruction to the target aircraft.

In some embodiments, the unlocking instruction may also include the identification identifying the to-be-unlocked aircraft.

In some embodiments, the identification may be an SN.

In some embodiments, the transceiver may transmit the alarm instruction to the target aircraft, after the processor outputs the navigation. The alarm instruction may command the target aircraft to sound an alarm and/or set off a warning light.

In some embodiments, the control device may be a remote controller, a smart wearable device, or a mobile communication device which are capable of communicating with the target aircraft via the wireless link.

The structure of the control device may be similar to the structure of the control device 900 in FIG. 9, which is not shown herein again. The control device can perform each process described in the foregoing embodiments in connection with FIGS. 1 to 3. To avoid repetition, the details are not described herein again.

Reference throughout this specification to “one embodiment” or “an embodiment” means that a particular feature, structure, or characteristic associated with the embodiment is included in at least one embodiment of the present disclosure. Hence, the appearance of “In some embodiments” or “in an embodiment” in various places throughout the specification is not necessarily referring to the same embodiment. Moreover, these specific features, structures, or characteristics can be combined in one or more embodiments in any suitable manner.

In various embodiments of the present disclosure, the magnitude of the sequence numbers of the above processes does not mean the order of the execution, and the execution sequence of each process should be determined by its function and internal logic, and should not be limited by the implementation process of the embodiments consistent with the present disclosure.

In the embodiments of the present disclosure, “B corresponds to A” means that B is associated with A, and according to A, B can be determined. But it should also be understood that, determining B according to A does not mean that B is only determined according to A. B can be determined according to A and/or other information.

The terms “and/or” used herein is merely an association describing an associated object, indicating that there may be three relationships. For example, A and/or B may indicate three cases, such as A exists alone, A and B both exist, and B exists alone. Moreover, the symbol “/” in the text generally indicates that the related objects in the context have an “or” relationship.

Persons of ordinary skill in the art can be aware that the exemplary units and algorithm steps describe in conjunction with the embodiments disclosed herein can be implemented in electronic hardware or a combination of computer software and electronic hardware. Whether these functions are implemented in hardware or software depends on the specific application of the technical solution and the constraint conditions of the design. Persons skilled in the art may use different methods to implement the described functions for each specific application, but it should not be considered that the implementation surpasses the scope of the present disclosure.

Persons skilled in the art can clearly understand that for convenience and brevity of description, specific working processes of the above-mentioned systems, apparatuses and units may refer to corresponding processes in the foregoing embodiments of methods, which are not repeated herein.

In the several embodiments provided in the present disclosure, the disclosed systems, devices, and methods may be implemented in other ways. For example, the embodiments of devices described above are merely schematic, e.g., the division of the unit is only a division of logic function, and there may be another manner of division in actual implementation. For example, multiple units or components may be combined or integrated into another system, or some features may be ignored or not performed. Moreover, the illustrated or discussed mutual coupling or direct coupling or communication connection may be indirect coupling or communication connection through some interfaces, devices, or units, and may be electrical, mechanical, or other forms.

The units described as separate components may or may not be physically separated, and the components displayed as units may or may not be physical units, that is, may be located in one place, or may be distributed on multiple network units. Some or all of the units may be selected according to actual needs to achieve the purpose of the solution of these embodiments.

Furthermore, each functional unit in each embodiment of the present disclosure may be integrated in one processing unit, or each unit may exist alone physically, or two or more units may be integrated in one unit.

The foregoing is merely a specific implementation manner of the present disclosure, but the scope of the present disclosure is not limited thereto. Changes or replacements, easily devised by any person skilled in the art within the technical scope disclosed by the present disclosure, should fall within the scope of the present disclosure. Therefore, the protection scope of the invention should be in accordance with the claims.

What is claimed is:

1. A troubleshooting method comprising:
receiving, by a target aircraft, a locking instruction instructing to lock the target aircraft; and
locking the target aircraft by the target aircraft according to the locking instruction.

2. The method according to claim 1, wherein locking the target aircraft according to the locking instruction comprises:
locking one or more of a flight control circuit, a gimbal, a motor, a camera, a positioning device, a power assembly, and an electronic speed governor of the target aircraft according to the locking instruction.

3. The method according to claim 1,
wherein the locking instruction comprises identification information identifying a to-be-locked aircraft;
the method further comprising:
determining that the target aircraft is the to-be-locked aircraft according to the identification information.

4. The method according to claim 1, wherein receiving the locking instruction comprises receiving the locking instruction from a server.

5. The method according to claim 1, wherein receiving the locking instruction comprises receiving the locking instruction from a control device.

6. The method according to claim 1, wherein:
wherein the locking instruction is encrypted;
the method further comprising, before locking the target aircraft:
decrypting the locking instruction.

7. The method according to claim 1, further comprising:
receiving an unlocking instruction instructing to unlock the target aircraft; and
unlocking the target aircraft according to the unlocking instruction.

8. The method according to claim 7,
wherein the unlocking instruction comprises identification information identifying a to-be-unlocked aircraft;
the method further comprising, before unlocking the target aircraft:
determining that the target aircraft is the to-be-unlocked aircraft according corresponding to the identification information.

9. The method according to claim 8, wherein the identification includes a serial number.

10. The method according to claim 7, wherein receiving the unlocking instruction comprises receiving the unlocking instruction from a server.

11. The method according to claim 7, wherein receiving the unlocking instruction comprises receiving the unlocking instruction from a control device.

12. The method according to claim 7,
wherein the unlocking instruction is encrypted;
the method further comprising, before unlocking the target aircraft:
decrypting the unlocking instruction.

13. The method according to claim 1, further comprising:
detecting whether a flight status of the target aircraft is normal; and
transmitting a locking request to at least one of a control device or a server in response to the flight status being abnormal;
wherein the locking instruction is transmitted by the at least one of the control device or the server according to the locking request.

14. The method according to claim 1, further comprising, after receiving the locking instruction:
acquiring, through a positioning device, information of a position of the target aircraft; and
transmitting the information of the position to a control device via a wireless link between the target aircraft and the control device.

15. The method according to claim 1, wherein the target aircraft is configured to communicate with a remote controller, a smart wearable device, or a mobile communication device via the wireless link.

16. The method according to claim 1, further comprising, after receiving the locking instruction:
performing at least one of sounding an alarm or setting off a warning light.

17. An aircraft comprising:
a transceiver configured to receive a locking instruction for locking the aircraft; and
a processor configured to lock the target aircraft according to the locking instruction.

18. The aircraft according to claim 17, wherein the processor is configured to lock one or more of a flight control circuit, a gimbal, a motor, a camera, a positioning device, a power assembly, and an electronic speed governor of the aircraft according to the locking instruction.

19. The aircraft according to claim 17, wherein:
the locking instruction comprises identification information identifying a to-be-locked aircraft; and
the processor is further configured to determine that the aircraft is the to-be-locked aircraft according to the identification information.

20. The aircraft according to claim 17, wherein the transceiver is further configured to receive the locking instruction from a server.
